(19) United States
(12) Patent Application Publication
(10) Pub. No.: US 2025/0373662 A1
(43) Pub. Date: Dec. 4, 2025

(54) MATCHING REGULATORY COMPLIANCE AND SECURITY RECOMMENDATIONS USING ARTIFICIAL INTELLIGENCE

(71) Applicant: Microsoft Technology Licensing, LLC, Redmond, WA (US)

(72) Inventor: Maor Nissan, Herzeliya (IL)

(21) Appl. No.: 18/731,028

(22) Filed: May 31, 2024

(51) Int. Cl. H04L 9/40

(52) U.S. Cl. CPC H04L 63/20

(57) ABSTRACT

Techniques for matching security recommendation tasks with a regulatory compliance standard are disclosed. A regulatory compliance standard is received as input at a first Machine Learning (ML) model. Security recommendation tasks are received as input at the first ML model. A distance matrix defining a threshold of alignment that specifies a distance between the security recommendation tasks and the regulatory compliance standard is determined by the first ML model. Based on the distance matrix, identifying a predetermined number N of the security recommendation tasks that are within the threshold of alignment. A prompt including the predetermined number N of the security recommendation tasks and the regulatory compliance standard is generated. The prompt is inputted to a second ML model. Based on the prompt, the second ML model identifies a subset of the predetermined number N of the security recommendation tasks that match the regulatory compliance standard.

### BACKGROUND

Cloud computing refers to the use of hosted services, such as data storage, servers, databases, networking, and software over the internet. The data is stored on physical servers, which are maintained by a cloud service provider. Computer system resources, especially data storage and computing power, are available on-demand, without direct management by the user in cloud computing.

Instead of storing files on a storage device or hard drive, a user can save them on cloud, making it possible to access the files from anywhere, as long as they have access to the web. The services hosted on cloud can be broadly divided into infrastructure-as-a-service (IaaS), platform-as-a-service (PaaS), and software-as-a-service (SaaS). Based on the deployment model, cloud can also be classified as public, private, and hybrid cloud.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for matching security recommendation tasks with a regulatory compliance standard, said method including: receiving as input at a first Machine Learning (ML) model a regulatory compliance standard; receiving as input at the first ML model security recommendation tasks; determining by the first ML model a distance matrix defining a threshold of alignment that specifies a distance between the security recommendation tasks and the regulatory compliance standard; based on the distance matrix, identifying a predetermined number N of the security recommendation tasks that are within the threshold of alignment, generating a prompt, the prompt including the predetermined number N of the security recommendation tasks and the regulatory compliance standard; inputting the prompt to a second ML model; and based on the prompt, identifying by the second ML model a subset of the predetermined number N of the security recommendation tasks that match the regulatory compliance standard.

In some aspects, the techniques described herein relate to a method for a cloud based security service to match security recommendation tasks with a regulatory compliance standard, said method including: receiving as input at a first Machine Learning (ML) model a regulatory compliance standard including regulatory compliance security tasks; receiving as input at the first ML model security recommendation tasks; determining by the first ML model a distance matrix defining a threshold of alignment that specifies a distance between the security recommendation tasks and one of the regulatory compliance security tasks; based on the distance matrix, identifying a predetermined number N of the security recommendation tasks that are within the threshold of alignment, generating a prompt, the prompt including the predetermined number N of security recommendation tasks and the one of the regulatory compliance security tasks; inputting the prompt to a second ML model; and based on the prompt, identifying by the second ML model a subset of the predetermined number N of the plurality of security recommendation tasks that match the one of the regulatory compliance security tasks.

In some aspects, the techniques described herein relate to a computer system including: a processor system; and a storage system that includes instructions that are executable by the processor system to cause the computer system to: receive as input at a first Machine Learning (ML) model a regulatory compliance standard security task; receive as input at the first ML model a first security recommendation task and a second security recommendation; define a threshold of alignment that specifies a distance between the first security recommendation task and the second security recommendation and the regulatory compliance standard security task; based on the distance matrix, identifying that the first security recommendation task and the second security recommendation task are within the threshold of alignment, generating a prompt, the prompt including the first security recommendation task and the second security recommendation task and the regulatory compliance standard security task; inputting the prompt to a second ML model; and based on the prompt, identifying by the second ML model that the first security recommendation task matches the regulatory compliance standard security task and that the second security recommendation task does not match the regulatory compliance standard security task. This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates aspects of a computing environment that includes a cloud security service.

FIGS. 2A and 2B illustrate aspects of a cloud security service.

FIGS. 3A-3E illustrate aspects of an AI matching module.

FIGS. 4A and 4B illustrate aspects of a visual representation of a distance matrix.

FIG. 5 illustrates a flowchart of an example method for using the AI matching module.

FIG. 6 illustrates an example computer system that can be configured to perform any of the disclosed operations.

### DETAILED DESCRIPTION

The disclosed embodiments generally deal with the problem of matching a number of available security recommendation tasks to a regulatory compliance standard. The disclosed embodiments bring about numerous benefits, advantages, and practical applications to the technical field of cloud based security. By way of example, the embodiments improve how a user is able to comply with regulatory compliance standards. In doing so, the embodiments remove the need for a user to manually match the available security recommendation tasks to the regulatory compliance standard, thereby improving how a computer system functions and operates. By improving the matching process, the embodiments also improve the user's experience with the computer system.

To achieve these benefits, the embodiments disclosed herein provide for an Artificial Intelligence (AI) matching module that in operation automatically matches the security recommendation tasks that correspond to regulatory compliance security tasks of a regulatory compliance standard. The AI matching module implements a machine learning or artificial intelligence model that matches the regulatory compliance standard to the security recommendation tasks using vector embeddings and generative AI. In this way, computing system resources are conserved since a user no longer has to perform the matching process manually. In addition, the user experience is improved as the user no longer need use a large amount of time to perform the matching process manually.

By performing the above operations, the embodiments significantly improve cloud computing security. Accordingly, these and numerous other benefits will now be described in more detail throughout the remaining sections of this disclosure.

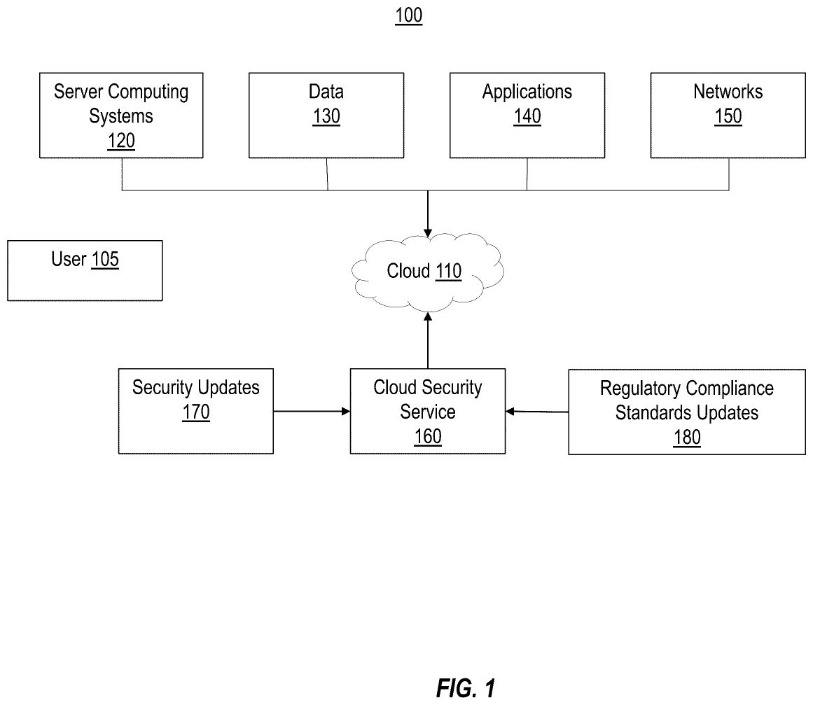

Having just described some of the high level benefits provided by the disclosed embodiments, attention will now be directed to FIG. 1, which illustrates an example computing environment 100 that can be used to achieve those benefits. The computing environment includes a cloud 110. Various cloud workloads belonging to a user 105, including, but not limited to, server computing systems 120, data 130, applications 140, and networks 150 are resident on and operate in the cloud 110.

In order to provide cloud based security to the various cloud workloads, the computing environment 100 includes cloud security service 160. In some implementations, cloud security service 160 is a cloud service operating in the cloud 110. In some implementations, cloud security service 160 is a local service operating on a local device. In some implementations, cloud security service 160 is a hybrid service that includes a cloud component operating in the cloud 110 and a local component operating on a local device. These two components can communicate with one another.

In operation, cloud security service 160 prevents, detects, and responds to security threats across the various cloud workloads and provides security task recommendations to the user 105. Accordingly, the cloud security service receives security updates 170 from various security related sources so that the cloud security service 160 is kept up to date on the newest security threats to the various cloud workloads.

The cloud security service 160 also tracks if the various cloud workloads are compliant with the security requirements of relevant regulatory compliance standards and provides compliance reports to the user 105. The relevant regulatory compliance standards are produced by government and industry groups such as the International Organization for Standardization (ISO) and specify a list of security tasks that represent best practices as determined by the government and industry groups. Thus, to be in compliance with a given regulatory compliance standard, a cloud workload needs to fulfil the list of security tasks or at least fulfil an acceptable percentage of the list of security tasks. Accordingly, cloud security service 160 receives regulatory compliance standards updates 180 from various regulatory sources such as government and industry groups so that cloud security service 160 includes the most up to date regulatory compliance standards.

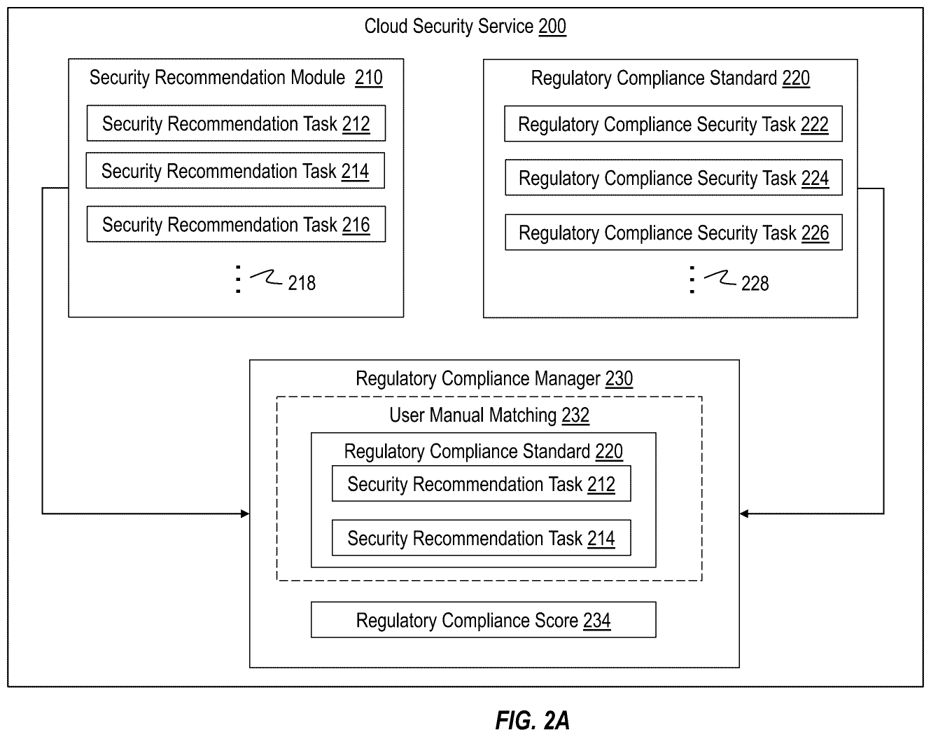

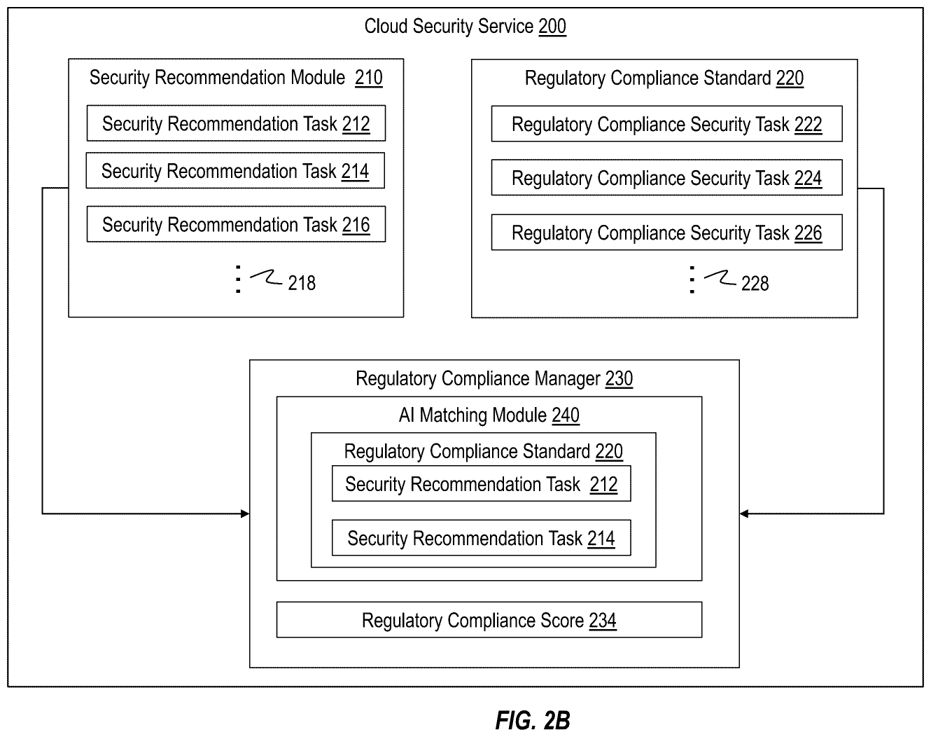

FIG. 2A illustrates an embodiment of cloud security service 200 that corresponds to cloud security service 160 previously described. Cloud security service 200 includes a security recommendation module 210. In the operation, the security recommendation module 210 provides security recommendations to the user 105 based on the security updates 170. The security recommendations specify specific security tasks that should be implemented by the user 105 on the various cloud workloads to thereby increase the overall security level of the of the cloud workloads. For example, the security recommendation module 210 provides a security recommendation task 212, a security recommendation task 214, a security recommendation task 216, and any number of additional security recommendation tasks 218 as illustrated by the ellipses. Thus, the user 105 is able to review the security recommendation tasks and determine which ones to implement. It will be appreciated that since there is a cost in computing resources and user time to implement all of the security recommendation tasks, the user 105 may choose to only implement a subset of the security recommendation tasks that provide an acceptable security level.

Cloud security service 200 also includes a regulatory compliance standard 220, which represents all the different regulatory compliance standards that can be implemented by the cloud security service. The regulatory compliance standard 220 may be updated by the regulatory compliance standards updates 180 as needed when changes are made by the organization that generates the regulatory compliance standard 220. The regulatory compliance standard 220 includes regulatory compliance security tasks related to security actions or security protocols that need to be complied with by a cloud workload for the cloud workload to be in compliance with the regulatory compliance standard 220. For example, the regulatory compliance standard 220 includes a regulatory compliance security task 222, a regulatory compliance security task 224, a regulatory compliance security task 226, and any number of additional regulatory compliance security tasks 228 as illustrated by the ellipses.

Cloud security service 200 also includes a regulatory compliance manager 230. In operation, the regulatory compliance manager 230 is able to generate a regulatory compliance score 234. The regulatory compliance score 234 is a measure of how well the regulatory compliance security tasks of the regulatory compliance standard 220 are being complied with by the cloud workloads. For example, in one embodiment the regulatory compliance score 234 would be 65 percent if only 65 percent of the regulatory compliance security tasks of the regulatory compliance standard 220 were being complied with.

In some embodiments, the regulatory compliance security tasks of the regulatory compliance standard 220, or at least a subset thereof, correspond to or are at least similar to some of the security recommendation tasks provided by the security recommendation module 210. In such embodiments, the user 105 can use the corresponding security recommendation tasks to show compliance with the regulatory compliance standard 220. For example, suppose that security recommendation tasks 212 and 214 corresponded to one or more of the regulatory compliance security tasks of the regulatory compliance standard 220. In such case, by matching the security recommendation tasks 212 and 214 with the regulatory compliance standard 220, the security recommendation tasks 212 and 214 can be used to show compliance with the regulatory compliance standard 220. This in turn may increase the regulatory compliance score 234, which can be useful in instances where the user 105 needs to show a high regulatory compliance score 234.

However, in some embodiments the process of matching the security recommendation tasks 212 and 214 with the regulatory compliance standard 220 is done by a user manual matching process 232, which requires the user 105 to manually match the security recommendations with the regulatory compliance standard. If there is a large number of security recommendation tasks, the user manual matching process 232 may require a large amount of user time and computing resources for the user 105 to compare the large number of security recommendation tasks with the regulatory compliance security tasks of the regulatory compliance standard 220 and then to match the corresponding security recommendation tasks with the regulatory compliance standard 220. In addition, any time the regulatory compliance security tasks of the regulatory compliance standard 220 are updated, the user manual matching process 232 may need to be repeated, again requiring a large amount of user time and computing resources.

Advantageously, the embodiments disclosed herein provide for an Artificial Intelligence (AI) matching module 240 as part of the regulatory compliance manager 230, as shown in FIG. 2B, that in operation automatically matches those security recommendation tasks that correspond to the regulatory compliance security tasks of the regulatory compliance standard 220. The AI matching module 240 implements a machine learning (ML) or artificial intelligence model that matches the regulatory compliance standard 220 to the security recommendation tasks using vector embeddings and generative AI as will be explained in more detail to follow. In this way, the computing system hosting the cloud security service 200 is improved as computing system resources are conserved since user 105 no longer has to perform the user manual matching process 232. In addition, the user 105 experience is improved as the user 105 no longer need use a large amount of time to perform the manual matching process 232.

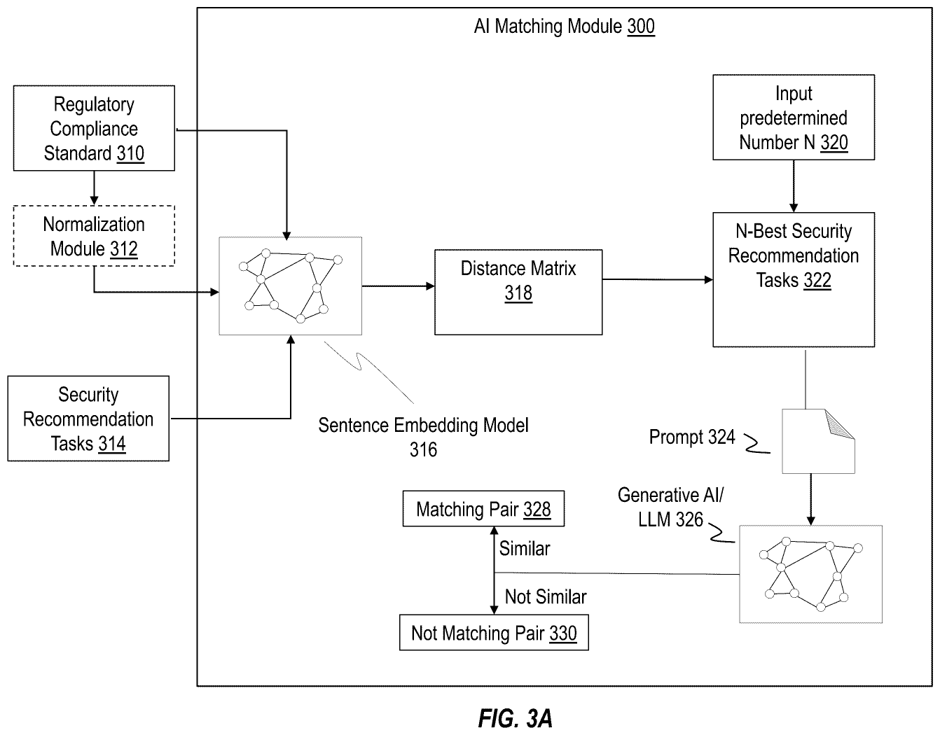

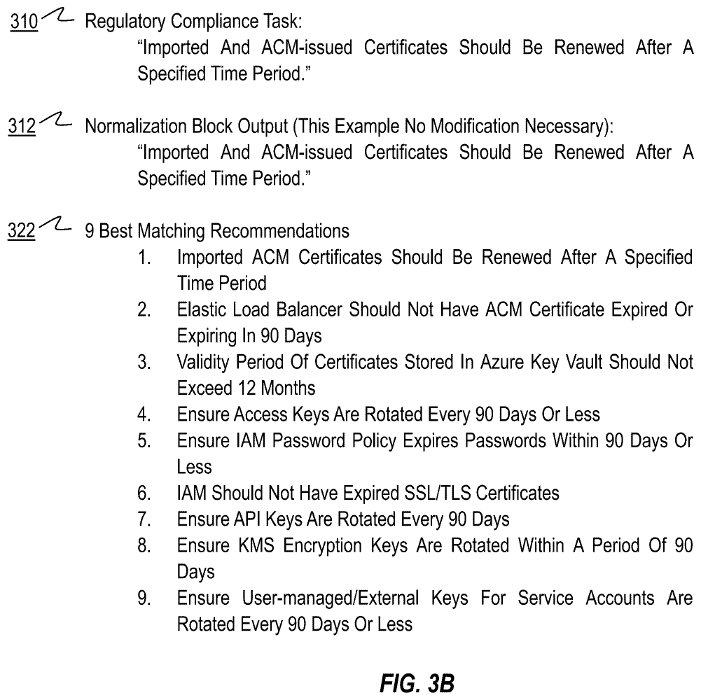

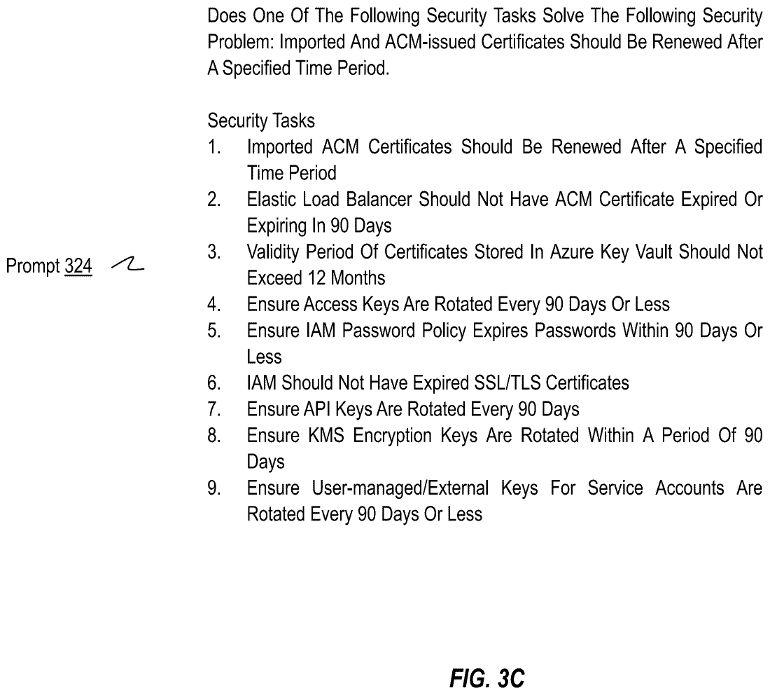

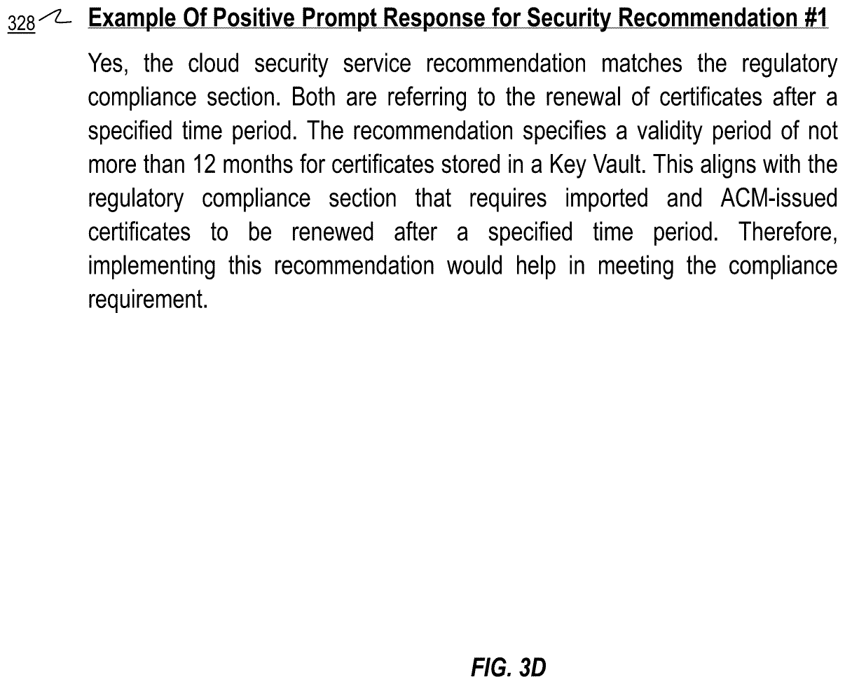

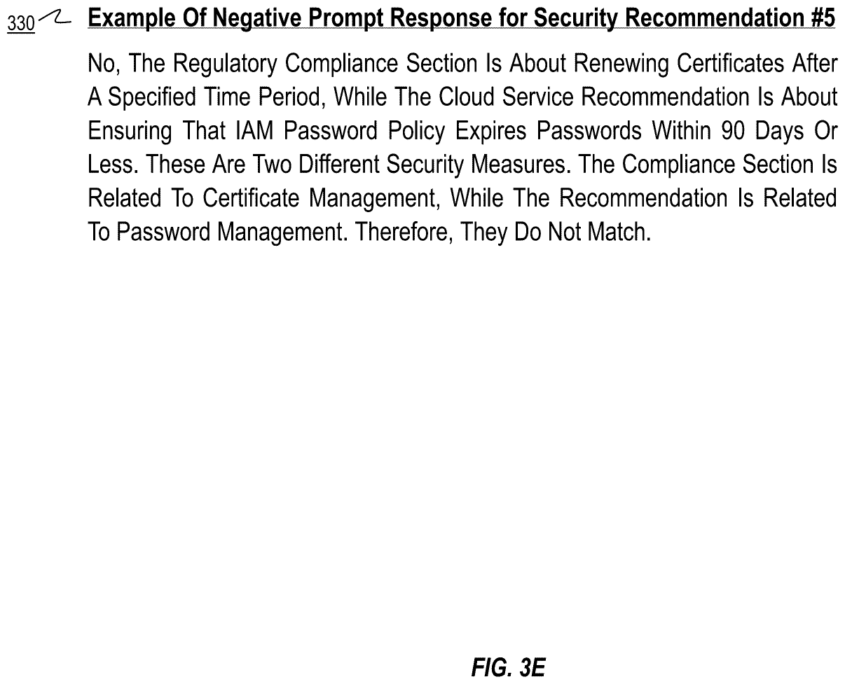

FIG. 3A illustrates an embodiment of an AI matching module 300, which corresponds to the AI matching module 240. As illustrated, the AI matching module 300 implements first and second ML or artificial intelligence models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The operation of the AI matching module 300 will now be explained. The AI matching module 300 receives as input a regulatory compliance standard 310, which corresponds to the regulatory compliance standard 220. In some embodiments, the regulatory compliance standard 310 is not the entire regulatory compliance standard, but is rather one or a small subset of the regulatory compliance security tasks 222, 224, 226, and 228.

In some embodiments, the regulatory compliance standard 310 is run through a normalization module 312. In operation, the normalization module 312 normalizes the regulatory compliance standard 310 into a structure that useable in matching to the security recommendation tasks 314, removes any unnecessary data, and keeps relevant data useable in the matching process.

The AI matching module 300 also receives as input security recommendation tasks 314, which correspond to the security recommendation tasks 212, 214, 216, and 218 previously described. In some embodiments, the security recommendation tasks 314 include only the title of the security recommendation tasks, but do not include any of the underlying information such as the code that implements the security recommendation tasks. Only including the title of the security recommendation tasks 314 may be helpful in further processing by the AI matching module 300.

The AI matching module 300 inputs the regulatory compliance standard 310, either directly or after the regulatory compliance standard has been run through the normalization module 312 into a first ML model of the AI matching module 300, which in the embodiment is a sentence embedding model 316. In addition, the AI matching module 300 inputs the security recommendation tasks 314 into the sentence embedding model 316.

The sentence embedding model 316 then parses the regulatory compliance standard 310 and security recommendation tasks 314 and generates embedding vectors for the parsed data. Different types of embeddings can optionally be used. For example, neural embeddings can be used, TF/IDF embeddings can be used, bag-of-word embeddings can be used, or any other type of embeddings can be used. The embedding vectors are numerical representations of the regulatory compliance standard 310 and each of the security recommendation tasks 314.

The sentence embedding model 316 then takes the embedding vectors and calculates a distance matrix 318 between the regulatory compliance standard 310 and the security recommendation tasks 314. The distance matrix 318 may be calculated using various distance metrics such as Euclidean distance, Manhattan distance, and Cosine similarity. Euclidean distance measures the straight-line distance between two points in a multi-dimensional space, while Manhattan distance considers the sum of absolute differences between corresponding features. Cosine similarity, on the other hand, quantifies the similarity between two vectors by calculating the cosine of the angle between them. This metric is commonly used for textual data analysis and information retrieval tasks.

Regardless of the distance metric used, the distance matrix 318 specifies the similarities between each of the security recommendation tasks 314 and the regulatory compliance standard 310.

In one embodiment, the distance matrix 318 measures how similar are the title of the security recommendation tasks 314 and the title of the regulatory compliance standard 310. That is, the title of the security recommendation and the title of the regulatory compliance standard without needing to include any other code or like associated with the security recommendation tasks 314 and the title of the regulatory compliance standard 310.

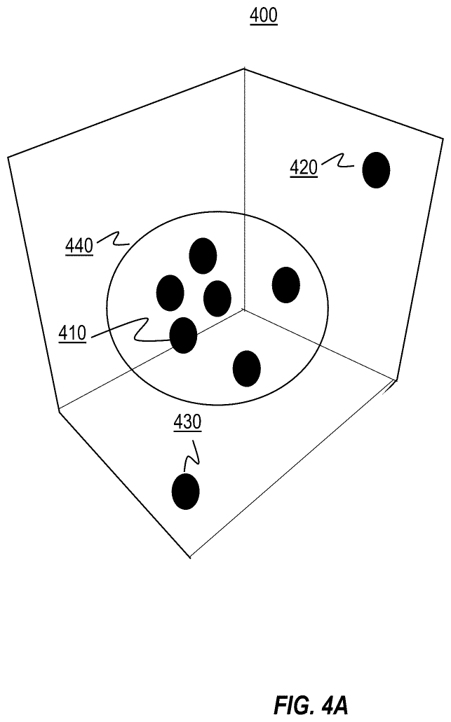

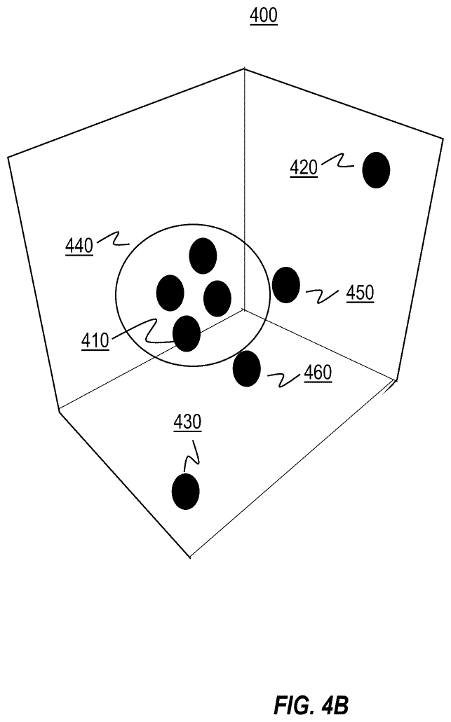

FIG. 4A illustrates a cluster graph 400 as a visualization of the distance matrix 318. As shown in graph, each of the dots represents the numerical representations of the regulatory compliance standard 310 and each of the security recommendation tasks 314. In the cluster graph 400, the dot 410 is the numerical representation of the regulatory compliance standard 310. The remaining dots represent each of the security recommendation tasks 314. It will be appreciated that in some embodiments, there may be a much larger number of security recommendation tasks 314 and thus the cluster graph 400 is for illustrative purposes only.

The distance matrix 318 specifies a distance between the numerical representation of the regulatory compliance standard 310 and the numerical representations each of the security recommendation tasks 314 based on the distance metric used to calculate the distance matrix. Thus, in the cluster graph 400 those security recommendation tasks 314 that are calculated to have a close distance to the regulatory compliance standard 310 are represented by dots close to the dot 410. Those security recommendation tasks 314 that are calculated to have some distance from the regulatory compliance standard 310, such as the security recommendation tasks represented by the dots 420 and 430 are shown as being some distance from the dot 410.

In the embodiments, the distance matrix 318 can define a threshold of alignment between the numerical representation of the regulatory compliance standard 310 and the numerical representations each of the security recommendation tasks 314. The numerical representations of each of the security recommendation tasks 314 that are within the threshold of alignment are considered in alignment with or similar to the numerical representation of the regulatory compliance standard 310. The threshold of alignment is based on the distances between the numerical representation of the regulatory compliance standard 310 and the numerical representations each of the security recommendation tasks 314. In the embodiments, the threshold of alignment can be set to any desired value, such as 50%, 60%, 70%, 80%, or even 99% or 100% depending on the desired precision, that is how close the numerical representations of the security recommendation tasks 314 need to be to the numerical representation of the regulatory compliance standard 310. It will be appreciated that the higher the value of the threshold of alignment, the closer the distance between the numerical representation of the regulatory compliance standard 310 and the numerical representations of a given one of the security recommendation tasks 314 will be. Thus, a lower threshold of alignment will include more security recommendation tasks 314, but with less precision and a higher threshold of alignment will include less security recommendation tasks 314, but with more precision

For example, FIG. 4A illustrates a threshold of alignment 440 represented by the circle in the cluster graph. All of the dots within the threshold of alignment 440 are considered to have a distance close enough to the dot 410 to be considered in alignment with or similar to the dot 410. FIG. 4B illustrates another embodiment of the cluster graph 400. In the cluster graph of FIG. 4B, the threshold of alignment 440 is set to a higher value than in FIG. 4A. Thus dots 450 and 460, which were within the threshold of alignment 440 in FIG. 4A, are outside of the threshold of alignment 440 in FIG. 4B.

Returning to FIG. 3A, the AI matching module 300 uses the distance matrix 318 to find 322 the N-best security recommendation tasks 314 that are within the threshold of alignment. In some embodiments, the AI matching module 300 includes an input module 320 that allows the user 105 to input a predetermined number N that will be used to find the N-best security recommendation tasks 314 that appear to match the regulatory compliance standard 310. For example, in one embodiment the user 105 may desire to find the 9 best security recommendation tasks 314 that appear to match the regulatory compliance standard 310 and 9 will be entered using the input module 320. Thus, the AI matching module 300 will use the distance matrix 318 and find the 9 best security recommendation tasks 314. Since the predetermined number N is configurable, the user is able to input any value needed for the user's circumstances.

FIG. 3B illustrates aspects of the operation of the AI matching module 300. As illustrated, a regulatory compliance task of the regulatory compliance standard 310 in the embodiment is “Imported And ACM-issued Certificates Should Be Renewed After A Specified Time Period.” As also illustrated, in the embodiment the output of the normalization module 312 was the same as the regulatory compliance standard 310 since no modifications to the regulatory compliance standard 310 were needed.

In the embodiment of FIG. 3B, the number 9 was entered into the input module 320 and so the AI matching module 322 uses the distance matrix 318 to find the 9 best security recommendation tasks 314 that appear to match the regulatory compliance standard 310. The 9 best matching recommendations are 1) “Imported ACM Certificates Should Be Renewed After A Specified Time Period”, 2) Elastic Load Balancer Should Not Have ACM Certificate Expired Or Expiring In 90 Days, 3) Validity Period Of Certificates Stored In Azure Key Vault Should Not Exceed 12 Months, 4) Ensure Access Keys Are Rotated Every 90 Days Or Less, 5) Ensure IAM Password Policy Expires Passwords Within 90 Days Or Less, 6) IAM Should Not Have Expired SSL/TLS Certificates, 7) Ensure API Keys Are Rotated Every 90 Days, 8) Ensure KMS Encryption Keys Are Rotated Within A Period Of 90 Days, and 9) Ensure User-managed/External Keys For Service Accounts Are Rotated Every 90 Days Or Less.

Returning to FIG. 3A, the AI matching module 300 takes the N-best security recommendation tasks 314 that are within the threshold of alignment and uses these to generate a prompt 324. The prompt 324 also includes the regulatory compliance standard 310. FIG. 3C illustrates an embodiment of the prompt 324. As illustrated, prompt 324 asks if one of the 9 best security recommendation tasks 314 that were found as previously described can solve the security problem of the regulatory compliance standard 310. The prompt 324 also lists the 9 best security recommendation tasks 314 and includes the regulatory compliance standard 310 in the question it asks.

Returning to FIG. 3A, the AI matching module 300 inputs the prompt 324 into a second ML model of the AI matching module 300, which is a generative AI/Large Language Model (LLM) 326 (more generally LLM 326). LLM 326 is some embodiments a type of neural network that uses various layers of nodes in a probabilistic manner. LLM 326 generates probabilities for words to form various groupings of words in response to the prompt 324.

Specifically, LLM 326 validates whether the N-best security recommendation tasks 314 that are within the threshold of alignment are in fact a match with the regulatory compliance standard 310. That is, while the distance matrix 318 found that the N-best security recommendation tasks 314 had some features that had a close distance to that of the regulatory compliance standard 310 and thus were included in the N-best, some of the security recommendation tasks may not actually be relevant to the regulatory compliance standard 310. For example, some of the security recommendation tasks 314 may have words in their titles that are similar to the regulatory compliance standard, but actually solve other problems than the regulatory compliance security tasks of the regulatory compliance standard 310. Thus, having LLM 326 identify which of the security recommendation tasks 314 are in fact a match to the regulatory compliance standard 310 and return a listing of the matches will automatically remove those security recommendation tasks 314 that are not a match.

Thus, as shown in FIG. 3A, those security recommendation tasks 314 that are similar to the regulatory compliance standard 310 are considered to be a matching pair 328 with the regulatory compliance standard. FIG. 3D illustrates a positive prompt response from LLM 326 for the security recommendation tasks 314 number 1 shown in FIG. 3B, which is “Imported ACM Certificates Should Be Renewed After A Specified Time Period.” As shown in FIG. 3D, the security recommendation tasks 314 number 1 shown in FIG. 3B is a match to the regulatory compliance standard 310 because both refer to the renewal of certificates after a specified time period. Thus, the security recommendation tasks 314 number 1 shown in FIG. 3B and the regulatory compliance standard 310 would be considered a matching pair 328.

In addition, security recommendation tasks 314 number 2 and security recommendation tasks 314 number 3 shown in FIG. 3B are also a match to the regulatory compliance standard 310 because they also refer to the renewal of certificates after a specified time period. Thus, the security recommendation tasks 314 number 2 shown in FIG. 3B and the regulatory compliance standard 310 and the security recommendation tasks 314 number 3 shown in FIG. 3B and the regulatory compliance standard 310 would be considered matching pairs 328.

Returning to FIG. 3A, in contrast those security recommendation tasks 314 that are not similar to the regulatory compliance standard 310 are considered to be a not matching pair 330 with the regulatory compliance standard. FIG. 3E illustrates a negative prompt response from LLM 326 for the security recommendation tasks 314 number 5 shown in FIG. 3B, which is “Ensure IAM Password Policy Expires Passwords Within 90 Days Or Less.” As shown in FIG. 3E, the security recommendation tasks 314 number 5 shown in FIG. 3B is not a match to the regulatory compliance standard 310 because security recommendation tasks 314 number 5 refers to password management and regulatory compliance standard 310 refers to certificate management. Thus, the security recommendation tasks 314 number 5 shown in FIG. 3B and the regulatory compliance standard 310 would be considered not a matching pair 330. In addition, the security recommendation tasks 314 number 4 and numbers 6-9 shown in FIG. 3B are not related to certificate management. Thus, the security recommendation tasks 314 number 4 and numbers 6-9 shown in FIG. 3B and the regulatory compliance standard 310 would be considered not a matching pair 330.

Returning to FIG. 2B, once the AI matching module 240 (i.e., AI matching module 300) determines the security recommendation tasks that match the regulatory compliance standard 220, these security recommendation tasks can be used by the regulatory compliance manager 230 to determine regulatory compliance score 234. Since the security recommendation tasks should be directly related to the regulatory compliance standard 220, the regulatory compliance score should be expected to be high.

However, if the regulatory compliance score 234 is still not at a value that is high enough for the needs of the user 105, the process described in FIGS. 3A-3E can be repeated, but with a larger predetermined number N. For example, in the embodiment of FIGS. 3A-3E, the predetermined number N was set at 9 and three security recommendation tasks were found to match the regulatory compliance standard 220. If a larger predetermined number N is selected, then the number of security recommendation tasks that appear to match the regulatory compliance standard 220 based on the distance matrix 318 will likely be larger, thus potentially providing more candidate security recommendation tasks that could match the regulatory compliance standard 220. This process can be repeated as needed until an acceptable regulatory compliance score 234 is reached.

The following discussion now refers to a number of methods and method acts that may be performed. It is noted that any operations of any of the methods disclosed herein, may be performed in response to, as a result of, and/or, based upon, the performance of any preceding operations. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

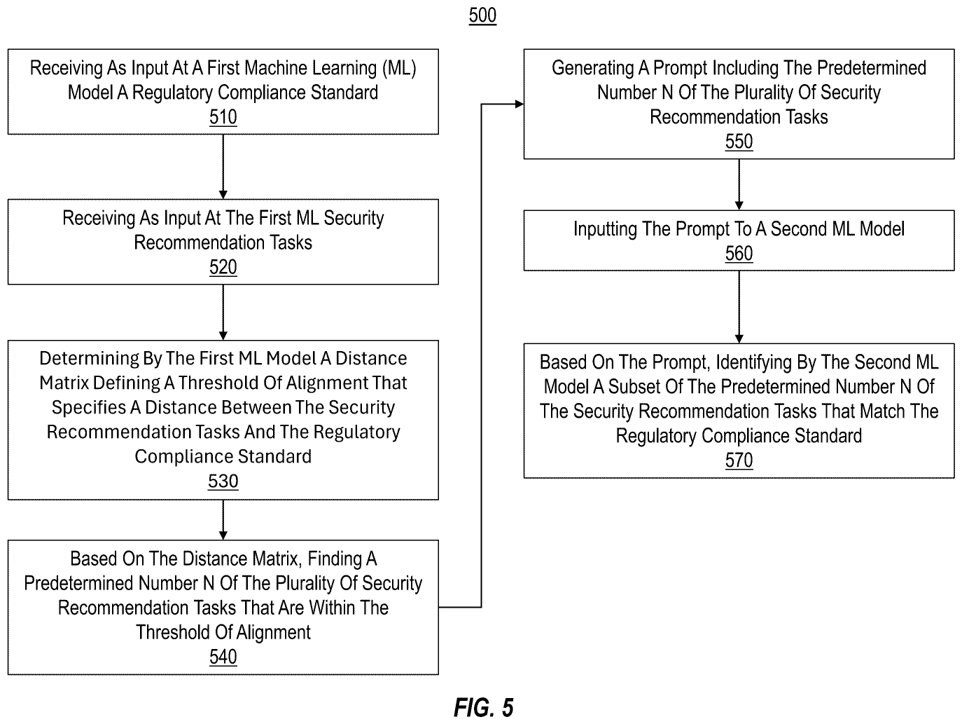

Directing attention now to FIG. 5, an example method 500 is disclosed. The method 500 will be described in relation to one or more of the figures previously described, although the method 500 is not limited to any particular embodiment.

The method 500 includes receiving as input at a first Machine Learning (ML) model a regulatory compliance standard (510). For example, as previously described the sentence embedding model 316 receives the regulatory compliance standard 310 or one of the regulatory compliance security tasks that comprise the regulatory compliance standard 310 as input.

The method 500 includes receiving as input at the first ML model security recommendation tasks (520). For example, as previously described the sentence embedding model 316 receives the security recommendation tasks 314, which correspond to the security recommendation tasks 212, 214, 216, and 218, as input.

The method 500 includes determining by the first ML model a distance matrix defining a threshold of alignment that specifies a distance between the security recommendation tasks and the regulatory compliance standard (530). For example, as previously described the sentence embedding model 316 determines the distance matrix 318. The distance matrix 318 defines threshold of alignment 440 that specifies the distance between the security recommendation tasks 314 and the regulatory compliance standard 310.

The method 500 includes based on the distance matrix, identifying a predetermined number N of the security recommendation tasks that are within the threshold of alignment (540). For example, as previously described the AI matching module 300 finds the predetermined number N or the N-best security recommendation tasks 314 that are within the threshold of alignment 440.

The method 500 includes generating a prompt, the prompt including the predetermined number N of the security recommendation tasks and the regulatory compliance standard (550). For example, as previously described the AI matching module 300 generates the prompt 324. The prompt 324 includes the predetermined number N of the security recommendation tasks 314 and the regulatory compliance standard 310.

The method 500 includes inputting the prompt to a second ML model (560). For example, as previously described the AI inputs the prompt 324 to the LLM 326.

The method 500 includes based on the prompt, identifying by the second ML model a subset of the predetermined number N of the security recommendation tasks that match the regulatory compliance standard (570). For example, as previously described the LLM 326 validates the predetermined number N of the security recommendation tasks 314 to identify the subset that matches the regulatory compliance standard 310 or one of the regulatory compliance security tasks that comprise the regulatory compliance standard 310. The security recommendation tasks 314 that match are part of the matching pairs 328 and the security recommendation tasks 314 that do not match are part of the not matching pairs 330.

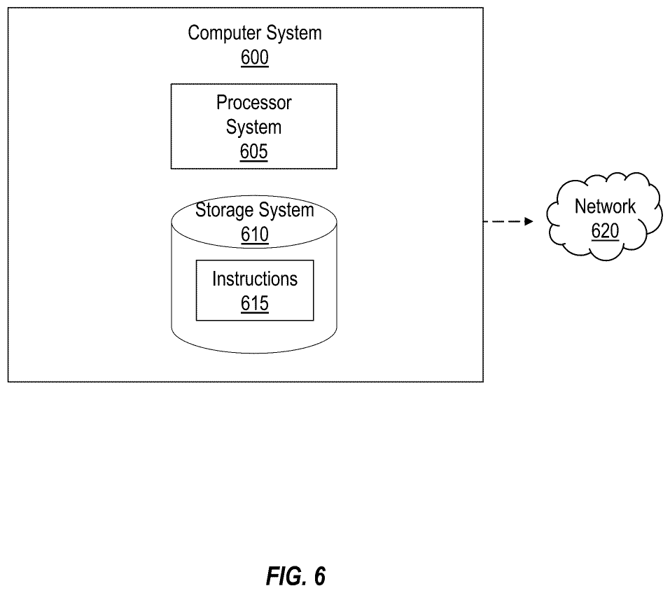

Attention will now be directed to FIG. 6 which illustrates an example computer system 600 that may include and/or be used to perform any of the operations described herein. Computer system 600 may take various different forms. For example, computer system 600 may be embodied as a tablet, a desktop, a laptop, a mobile device, or a standalone device, such as those described throughout this disclosure. Computer system 600 may also be a distributed system that includes one or more connected computing components/devices that are in communication with computer system 600. Computer system 600 can implement the embodiments of the previous figures.

In its most basic configuration, computer system 600 includes various different components. FIG. 6 shows that computer system 600 includes a processor system 605 that includes one or more processor(s) (aka a “hardware processing unit”) and a storage system 610.

Regarding the processor(s) of the processor system 605, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 600. The different components, modules, engines, and services described herein may be implemented as objects or processors that execute on computer system 600 (e.g. as separate threads).

Storage system 610 may include physical system memory, which may be volatile, non-volatile, or some combination of the two. The term “memory” may also be used herein to refer to non-volatile mass storage such as physical storage media. If computer system 600 is distributed, the processing, memory, and/or storage capability may be distributed as well.

Storage system 610 is shown as including executable instructions 615. The executable instructions 615 represent instructions that are executable by the processor(s) of processor system 605 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 600 may also be connected (via a wired or wireless connection) to external sensors (e.g., one or more remote cameras) or devices via a network 620. For example, computer system 600 can communicate with any number devices or cloud services to obtain or process data. In some cases, network 620 may itself be a cloud network. Furthermore, computer system 600 may also be connected through one or more wired or wireless networks to remote/separate computer systems(s) that are configured to perform any of the processing described with regard to computer system 600.

A “network,” like network 620, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 600 will include one or more communication channels that are used to communicate with the network 620. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for matching security recommendation tasks with a regulatory compliance standard, said method comprising:
receiving as input at a first Machine Learning (ML) model a regulatory compliance standard;
receiving as input at the first ML model security recommendation tasks;
determining by the first ML model a distance matrix defining a threshold of alignment that specifies a distance between the security recommendation tasks and the regulatory compliance standard;
based on the distance matrix, identifying a predetermined number N of the security recommendation tasks that are within the threshold of alignment,
generating a prompt, the prompt including the predetermined number N of the security recommendation tasks and the regulatory compliance standard;
inputting the prompt to a second ML model; and
based on the prompt, identifying by the second ML model a subset of the predetermined number N of the security recommendation tasks that match the regulatory compliance standard.

2. The method of claim 1, wherein the first ML model is a sentence embedding model.

3. The method of claim 2, wherein the sentence embedding model generates embedding vectors for the security recommendation tasks and the regulatory compliance standard and generates the distance matrix based on the embedding vectors.

4. The method of claim 1, wherein the second ML model is a Large Language Model (LLM).

5. The method of claim 1, wherein the predetermined number N is determined by a user of a computing system performing the method.

6. The method of claim 1, further comprising:
normalizing the regulatory compliance standard prior to inputting the regulatory compliance standard into the first ML model.

7. The method of claim 1, wherein the subset of the predetermined number N of the security recommendation tasks that match the regulatory compliance standard are used to determine a regulatory compliance score.

8. A method for a cloud based security service to match security recommendation tasks with a regulatory compliance standard, said method comprising:
receiving as input at a first Machine Learning (ML) model a regulatory compliance standard comprising regulatory compliance security tasks;
receiving as input at the first ML model security recommendation tasks;
determining by the first ML model a distance matrix defining a threshold of alignment that specifies a distance between the security recommendation tasks and one of the regulatory compliance security tasks;
based on the distance matrix, identifying a predetermined number N of the security recommendation tasks that are within the threshold of alignment,
generating a prompt, the prompt including the predetermined number N of security recommendation tasks and the one of the regulatory compliance security tasks;
inputting the prompt to a second ML model; and
based on the prompt, identifying by the second ML model a subset of the predetermined number N of the security recommendation tasks that match the one of the regulatory compliance security tasks.

9. The method of claim 1, wherein the first ML model is a sentence embedding model.

10. The method of claim 9, wherein the sentence embedding model generates embedding vectors for the security recommendation tasks and the one of the regulatory compliance security tasks and generates the distance matrix based on the embedding vectors.

11. The method of claim 8, wherein the second ML model is a Large Language Model (LLM).

12. The method of claim 8, wherein the predetermined number N is determined by a user of a computing system performing the method.

13. The method of claim 1, further comprising:
normalizing the one of the regulatory compliance security tasks prior to inputting the regulatory compliance standard into the first ML model.

14. The method of claim 1, wherein a title of the security recommendation tasks is input into the first ML model.

15. A computer system comprising:
a processor system; and
a storage system that includes instructions that are executable by the processor system to cause the computer system to:
receive as input at a first Machine Learning (ML) model a regulatory compliance standard security task;
receive as input at the first ML model a first security recommendation task and a second security recommendation;
determine by the first ML model a distance matrix that defines a threshold of alignment that specifies a distance between the first security recommendation task and the second security recommendation and the regulatory compliance standard security task;
based on the distance matrix, identifying that the first security recommendation task and the second security recommendation task are within the threshold of alignment,
generating a prompt, the prompt including the first security recommendation task and the second security recommendation task and the regulatory compliance standard security task;
inputting the prompt to a second ML model; and
based on the prompt, identifying by the second ML model that the first security recommendation task matches the regulatory compliance standard security task and that the second security recommendation task does not match the regulatory compliance standard security task.

16. The computer system of claim 15, wherein the first ML model is a sentence embedding model.

17. The computer system of claim 16, wherein the sentence embedding model generates embedding vectors for the first security recommendation task and the second security recommendation task and the regulatory compliance standard security task and generates the distance matrix based on the embedding vectors.

18. The computer system of claim 15, wherein the second ML model is a Large Language Model (LLM).

19. The computer system of claim 15, further comprising:
normalizing the regulatory compliance standard security task prior to inputting the regulatory compliance standard into the first ML model.

20. The computer system of claim 15, wherein a title of the first and second security recommendation tasks are input into the first ML model.
